(19) United States
(12) Patent Application Publication
(10) Pub. No.: US 2015/0270910 A1
(43) Pub. Date: Sep. 24, 2015

(54) METHOD AND APPARATUS FOR IMPULSE NOISE MITIGATION FOR POWER LINE NETWORKING

(71) Applicant: Enphase Energy, Inc., Petaluma, CA (US)

(72) Inventors: Zvi Bernstein, San Jose, CA (US); Kennan Laudel, San Jose, CA (US); Madhavi Anugu, San Jose, CA (US)

(21) Appl. No.: 14/665,782

(22) Filed: Mar. 23, 2015

Related U.S. Application Data
(60) Provisional application No. 61/968,944, filed on Mar. 21, 2014.

(51) Int. Cl. H04B 15/00; H04B 3/54

(52) U.S. Cl. CPC H04B 15/00; H04B 3/54

(57) ABSTRACT

A method and apparatus for impulse noise mitigation. In one embodiment, the method comprises identifying one or more impulse noise affected samples of a communication signal transmitted via power line communications; creating, based on the identified one or more impulse-noise affected samples, one or more erasures; and adaptively controlling a correlation threshold for packet preamble detection, wherein the correlation threshold is adaptively controlled based on the one or more erasure.

### CROSS-REFERENCE TO RELATED APPLICATIONS

This application claims benefit of U.S. provisional patent application Ser. No. 61/968,944, entitled “Impulse Noise Mitigation for Power Line Networking” and filed Mar. 21, 2014, which is herein incorporated in its entirety by reference.

### BACKGROUND OF THE INVENTION

1. Field of the Invention

Embodiments of the present disclosure relate generally to impulse noise mitigation, and, in particular, to mitigating impulse noise impact on packet preamble detection.

2. Description of the Related Art

Impulse noise in communications systems is a category of noise which includes unwanted spikes or sharp pulses. Impulse noise is one of the most difficult transmission impairments to suppress and can cause severe performance degradation in communications.

In power line communication (PLC) systems, changing load on the power network results in unwanted impulse noise that may affect the ability of a receiver to detect transmitted packets. For example, a voltage spike due to impulse noise may make it impossible for the receiver to identify a packet preamble and thus lose the entire packet. Such impulse noise effects are particularly difficult to overcome in systems using protocols where packet deliveries are not scheduled in advance and the receiver has no a priori knowledge about when packets will arrive.

Therefore, there is a need in the art for a method and apparatus for efficiently mitigating the effects of impulse noise in communications.

### SUMMARY OF THE INVENTION

Embodiments of the present invention generally relate to impulse noise mitigation as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a communication system in accordance with one or more embodiments of the present invention;

FIG. 2 is a functional block diagram of a receiver in accordance with one or more embodiments of the present invention;

FIG. 3 is a block diagram of an impulse noise mitigation module in accordance with one or more embodiments of the present invention;

FIG. 4 is a block diagram of a system for power conversion using one or more embodiments of the present invention;

FIG. 5 is a functional block diagram of another embodiment of a receiver in accordance with one or more embodiments of the present invention;

FIG. 6 (comprised of FIGS. 6a and 6b) is a flow diagram of a method for generating erasures for impulse noise mitigation during power line communication packet preamble detection in accordance with one or more embodiments of the present invention; and

FIG. 7 is a flow diagram of a method for using erasures for power line communication impulse noise mitigation during packet preamble detection in accordance with one or more embodiments of the present invention.

### DETAILED DESCRIPTION

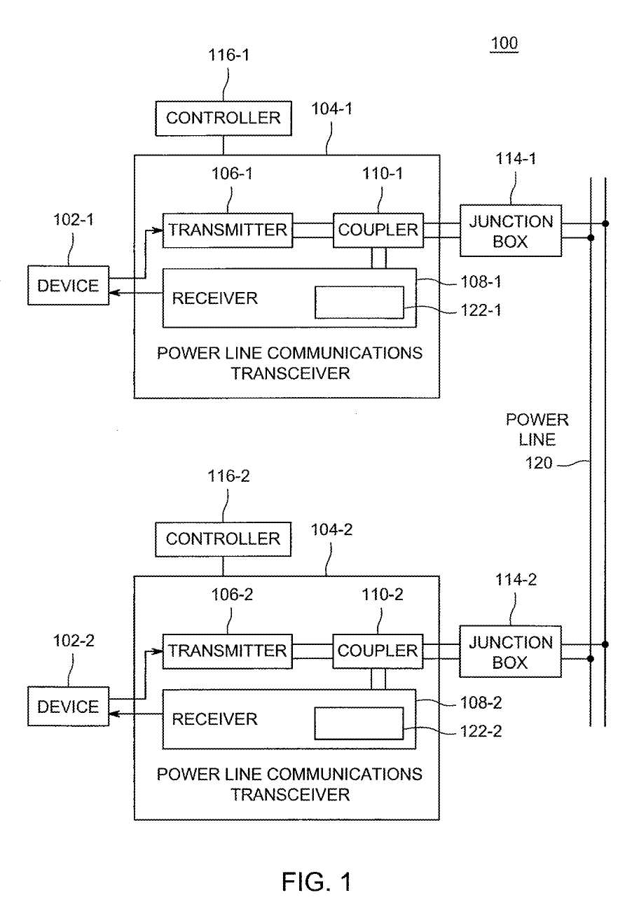

FIG. 1 is a block diagram of a communication system 100 in accordance with one or more embodiments of the present invention. This diagram only portrays one variation of the myriad of possible system configurations. The present invention can function in a variety of environments and systems.

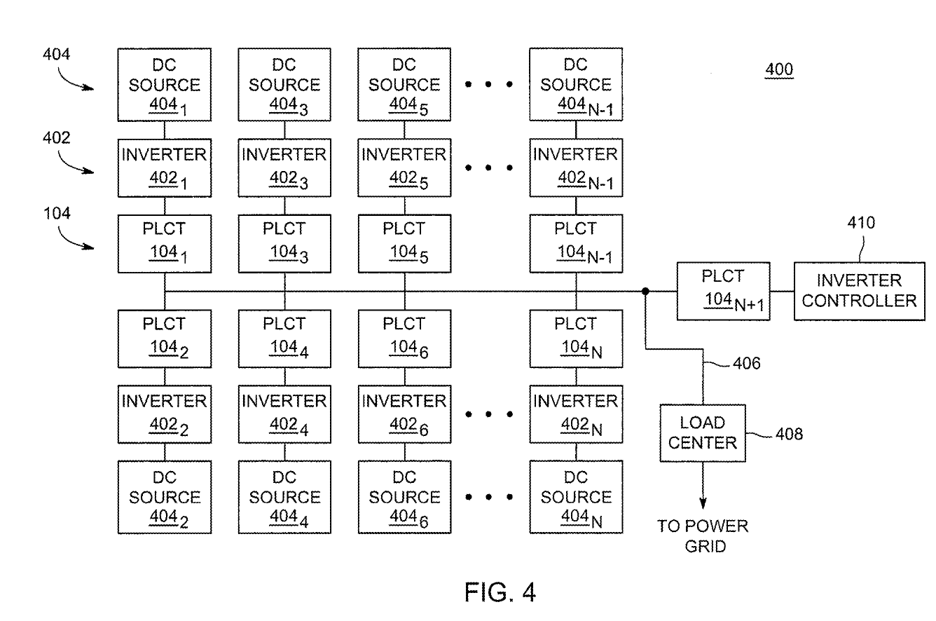

The system 100 comprises a device 102-1 coupled to a power line communications transceiver (PLCT) 104-1, which is further coupled to an AC power line 120 (“power line 120”) via a junction box 114-1. Additionally, the system 100 comprises a device 102-2 coupled to a PLCT 104-2, which is further coupled to the power line 120 via a junction box 114-2. The devices 102-1 and 102-2, collectively referred to as devices 102, are devices requiring communications bandwidth for transmitting and/or receiving data, such as a home computer, peripheral device, power converters, and the like, and are capable of communicating with one another over the power line 120 via the PLCTs 104-1 and 104-2, respectively. In some embodiments, the PLCT 104-1 and/or the PLCT 104-2 may be coupled directly to the power line 120 without the use of junction boxes 114-1/114-2. One particular embodiment that uses the inventive system is described below with respect to FIG. 4.

The PLCT 104-1 comprises a transmitter 106-1 and a receiver 108-1, each coupled to the device 102-1, and a coupler 110-1 that couples both the transmitter 106-1 and the receiver 108-1 to the junction box 114-1. When the PLCT 104-1 is operating in a “transmit mode”, the transmitter 106-1 is capable of transmitting data to the device 102-2 via the power line 120.

The receiver 108-1 is capable of receiving data from the device 102-2 via the power line 120. The PLCT 104-1 may be able to simultaneously receive and transmit data; however, the transmitter 106-1 may generally blind the receiver 108-1 while active. In some embodiments, a PLCT controller 116-1 is coupled to the PLCT 104-1 and provides various control for the PLCT 104-1. The PLCT controller 116 may be separate from the PLCT 104-1 as depicted in FIG. 1, or, alternatively, the PLCT controller 116-1 may be a component of the PLCT 104-1.

Analogous to the PLCT 104-1, the PLCT 104-2 comprises a transmitter 106-2, a receiver 108-2, and a coupler 110-2. The transmitter 106-2 and receiver 108-2 are coupled to the device 102-2 as well as the coupler 110-2, and the coupler 110-2 is further coupled to the junction box 114-2. In some embodiments, a PLCT controller 116-2 is coupled to the PLCT 104-2 and provides various controls for the PLCT 104-2. The PLCT controller 116-2 may be separate from the PLCT 104-2 as depicted in FIG. 1, or, alternatively, the PLCT controller 116-2 may be a component of the PLCT 104-2. The PLCT 104-2 transmits and receives analogous to the PLCT 104-1.

During operation, the transmitters 106 receive data from the corresponding devices 102 and, based on the received data, generate and transmit data packets for reception by the corresponding downstream receiver 108. In some embodiments, the data transmission may be based on a protocol where packets are not scheduled on the medium in advance, such as carrier sense multiple access (CSMA).

Each of the data packets comprises a preamble at the beginning of the packet for synchronization at the receiver 108. In accordance with one or more embodiments of the present invention, the receivers 108-1 and 108-2 comprise impulse noise mitigation modules 122-1 and 122-2, respectively, for mitigating the effects of impulse noise in detecting the preambles of received packets as described in detail below.

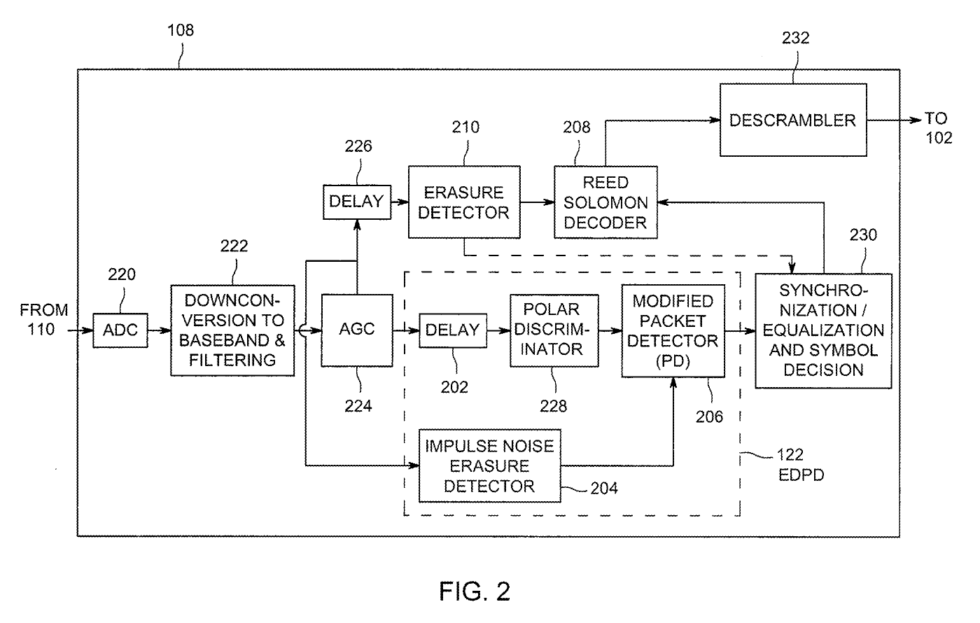

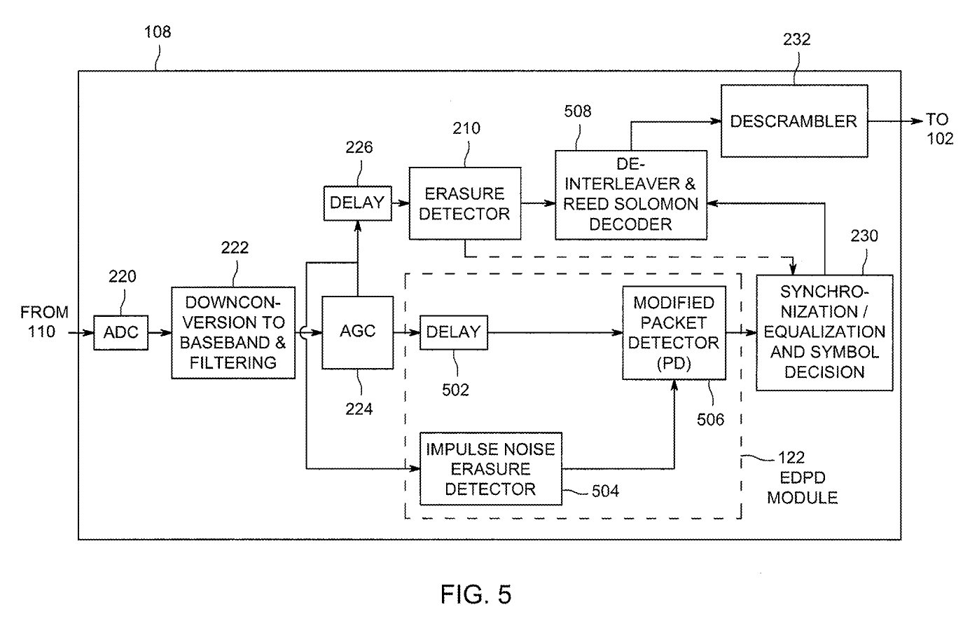

FIG. 2 is a functional block diagram of a receiver 108 in accordance with one or more embodiments of the present invention. In some embodiments, such as the embodiment depicted in FIG. 2, frequency shift keying (FSK) modulation is used in the system 100, as well as Reed Solomon coding. FIG. 5 depicts another embodiment of a receiver 108 in which other modulation techniques may be used (described further below with respect to FIG. 5).

The receiver 108 of FIG. 2 comprises an analog to digital converter (ADC) 220 that receives an analog input from the coupler 110 and converts the received analog input to a digital output that is coupled to a down-conversion module 222. The down-conversion module 222 comprises a mixer and a filter and converts the received signal to a baseband signal and performs low-pass filtering to remove high-frequency content.

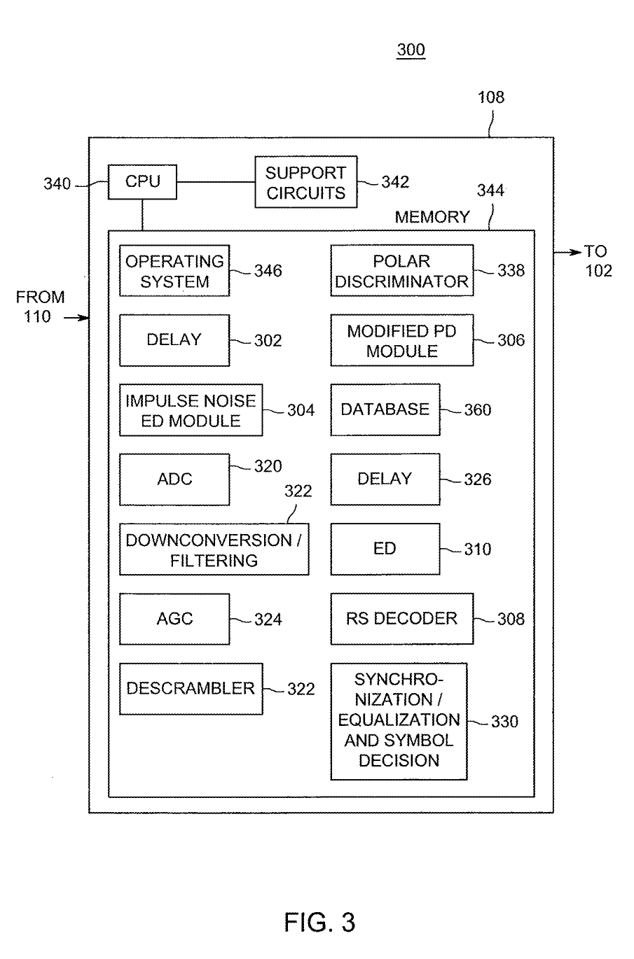

The output from the down-conversion module 222 is coupled to an automatic gain control (AGC) module 224, and an output from the AGC module 224 is coupled to a delay module 226 and to an impulse noise erasure detector (ED) module 204 (an implementation of the impulse noise ED module 318 described below with respect to FIG. 3). An output from the AGC module 224 is coupled to a delay module 202, and the output from the delay module 202 is coupled to a polar discriminator 228. The outputs from the polar discriminator 228 and the impulse noise ED module 204 are coupled to a modified packet detector (PD) module 206 (an implementation of the modified PD module 320 described below with respect to FIG. 3). The delay module 202, the impulse noise ED module 204, the polar discriminator 228, and the PD 206 form an erasure detection for packet detector (EDPD) module 122 for impulse noise mitigation. The output from the PD 206 (i.e., the output from the EDPD module 122) is coupled to a synchronization/equalization and symbol decision module 230.

In addition to coupling an output to the delay module 202, the AGC module 224 couples an output to the delay module 226, and the output from the delay module 226 is coupled to an erasure detector (ED) module 210. The outputs from the ED module 210 and the synchronization/equalization and symbol decision module 230 are each coupled to a Reed-Solomon (RS) decoder 208. The RS-corrected symbols output from the RS decoder 208 are coupled to a de-scrambler module 232 for de-scrambling; and the output from the de-scrambler 232 is coupled to the device 102. In some embodiments, the ED module 210 may couple an output to the synchronization/equalization and symbol decision module 230.

In the receiver 108 as depicted in FIG. 2, the ED module 210 feeds erasures to the RS decoder 208 for correcting symbols in the payload that have been corrupted by impulse noise (the RD decoder 208 has the capability to accept erasures and correct them, up to a theoretical limit) as known in the art. In accordance with one or more embodiments of the present invention, the EDPD module 122 employs impulse noise mitigation for packet preamble detection. The impulse noise ED 204 receives a smoothed AGC gain signal, detects impulse noise and creates erasures (i.e., samples marked for erasure) for the modified PD 206, which uses these erasures to adaptively control a correlation threshold used in detection of a packet preamble. The modified PD 206 effectively treats the erasures as zeroes during a correlation between a known sequence and the received samples; the result of the correlation is compared to the correlation threshold for determining whether a packet preamble has been detected. The modified PD 206 adjusts its correlation threshold based on the number of erasures received; because the erased preamble samples produce a correlation intermediate result of zero, the correlation threshold must be reduced accordingly as the number of erasures increases. For example, in one or more embodiments where a 64-symbol correlation is used, the correlation threshold for preamble detection would be adjusted by the number of erasures divided by 64. In some alternative embodiments, the modified PD 206 may be bypassed and the erasures not used (for example, by suitably setting a control bit).

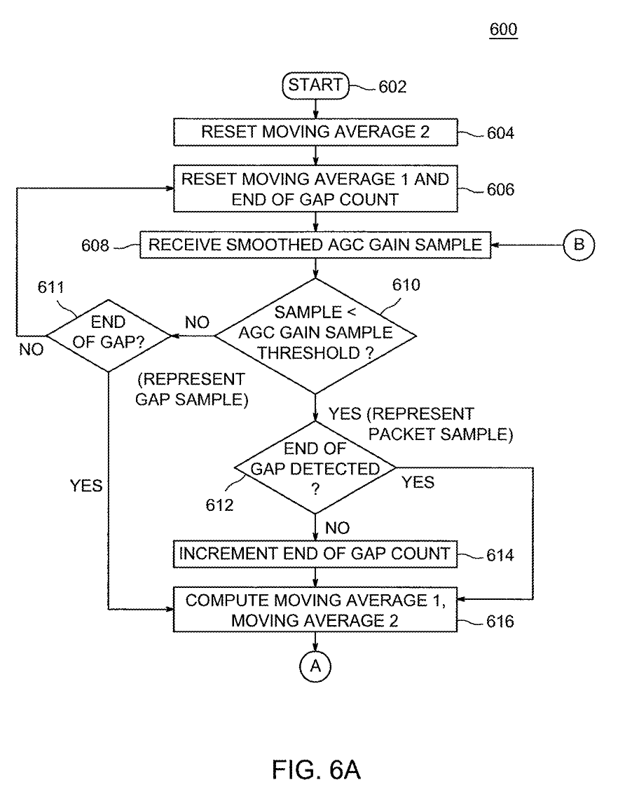

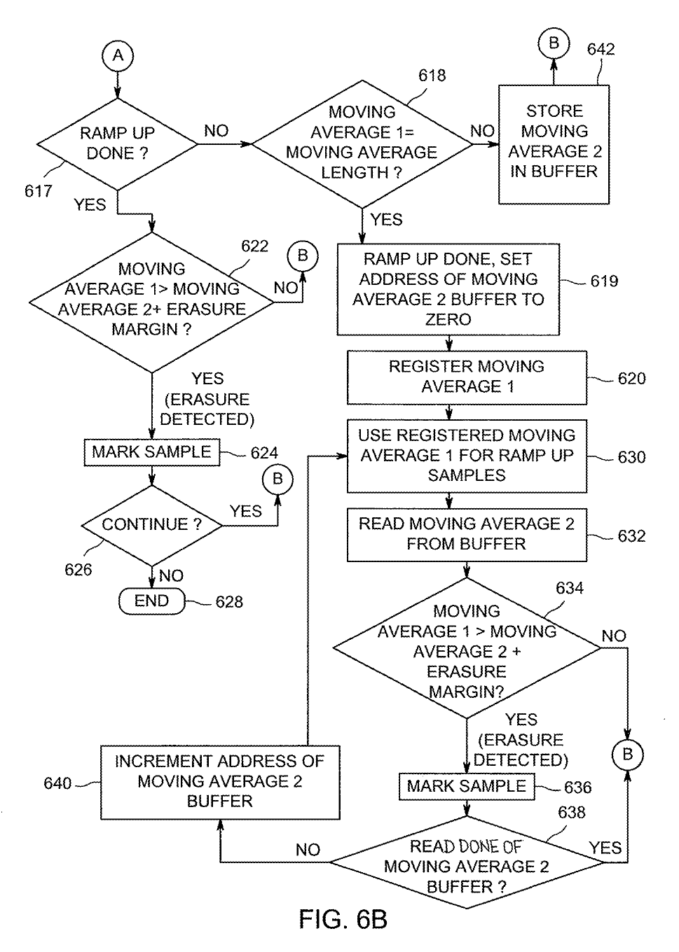

As part of the impulse noise mitigation techniques described herein, the impulse noise ED module 204 uses two moving average (MA) circuits in parallel operating on the AGC gain signal—one long MA, and one short MA. Based on the outputs from the MA circuits, thresholds and comparison logic determine the location of impulse noise-affected samples and insert erasures for these samples. These erasures are transmitted to the modified PD 206, which detects preamble via correlation. The modified PD 206 performs a hard decision cross correlation (HDCC) for packet detection and a soft decision cross correlation (SDCC) for header start and symbol boundary using these erasures. The modified PD 206 computes and scales the number of erasures during the preamble and uses such information to adaptively scale the correlation thresholds for both the HDCC and SDCC. By using this adaptive scaling, a preamble where 48 out of 64 symbols have been erased and only 16 symbols are valid can still be detected. In some embodiments, these techniques can be utilized with a longer preamble to realize 4 msec impulse noise mitigation. In order to be insensitive to gap length, the impulse noise ED module 204 employs a threshold (referred to as an “AGC gain sample threshold” in FIG. 6 described below) to detect when the (inter-frame) gap stops and the signal starts. Ramp-up of the MAs is replaced with an extension of the first MA after ramp-up is complete in order to eliminate the false or mis-detection of erasures during the MA ramp-up. In those embodiments where transmissions are not scheduled, such as in a carrier sense multiple access (CSMA) network, there is no a priori knowledge of when transmissions will occur. Impulse noise bursts and signal packets could come at any time—independently or jointly. For this reason, an Infinite impulse response (IIR) smoothing filter on the AGC gain is used, and thresholds, hysteresis and control logic are used to help determine and keep track of the Start of Gap (SOG) and End of Gap (EOG). In some embodiments, the IIR filter is a 1 pole Infinite Impulse Response (IIR) filter with one programmable coefficient having values such as 0.5, 0.75, 0.875, 0.9375, 0.96875, 0.984375, and the like. Additional logic is used to properly keep track of SOG/EOG for corner cases. An example of such a case is where a bad header is detected (and the packet length is unknown) mid-packet.

In some embodiments, a media access control (MAC) layer (OSI layer 2) maintenance cycle that enables proper threshold settings in the EDPD module 122 is employed. The maintenance cycle contains a ‘quiet’ period so that the EDPD module 122 can train to the background noise, and a constant envelope maintenance packet or burst signal that allows the EDPD module 122 to train to the signal level. The maintenance cycle can be invoked periodically or ‘on demand’ when sudden signal degradation has been detected (relative to previous signals). The latter could be caused when a light dimmer has been turned on, for example.

In some embodiments, the impulse noise mitigation techniques described above improve the impulse noise duration PER=1% point for 5/20 kB by approximately 2-3×.

The impulse noise mitigation techniques described herein using an adaptive threshold allow a smaller preamble to be used and reduce overhead relative to a modem which does not use this technique and is required to mitigate the same impulse noise durations. However, with periodic impulse noise the length of the preamble has practical limitations whereby a longer preamble may not always improve the performance. Additionally, the present invention mitigates the impulse noise from certain compact fluorescent lights and LEDs, common sources of impulse noise that can be difficult to compensate for. In some embodiments, symbol rates of 5 kB or 20 kB may be used, although in other embodiments other symbol rates may be used.

FIG. 3 is a block diagram of a receiver 108 in accordance with one or more embodiments of the present invention. The receiver 108 may be comprised of hardware, software, or a combination thereof, and may in certain embodiments comprise a central processing unit (CPU) 340 coupled to support circuits 342 and memory 344. The CPU 340 may comprise one or more conventionally available microprocessors, microcontrollers and the like, which are capable of performing the processing described herein; in some embodiments, the CPU 340 may be a microcontroller comprising internal memory for storing controller firmware that, when executed, provides the functionality described herein. Alternatively, the CPU 340 may include one or more application specific integrated circuits (ASICs). The support circuits 342 are well known circuits used to promote functionality of the CPU 340. Such circuits include, but are not limited to, a cache, power supplies, clock circuits, buses, network cards, input/output (I/O) circuits, and the like. The receiver 108 may be implemented using a general purpose computer that, when executing particular software, becomes a specific purpose computer for performing various embodiments of the present invention.

The memory 344 may comprise random access memory, read only memory, removable disk memory, flash memory, and various combinations of these types of memory. The memory 344 is sometimes referred to as main memory and may, in part, be used as cache memory or buffer memory. The memory 344 generally stores the operating system (OS) 346 of the receiver 108. The OS 346 may be one of a number of commercially available OSs such as, but not limited to, Linux, Real-Time Operating System (RTOS), and the like.

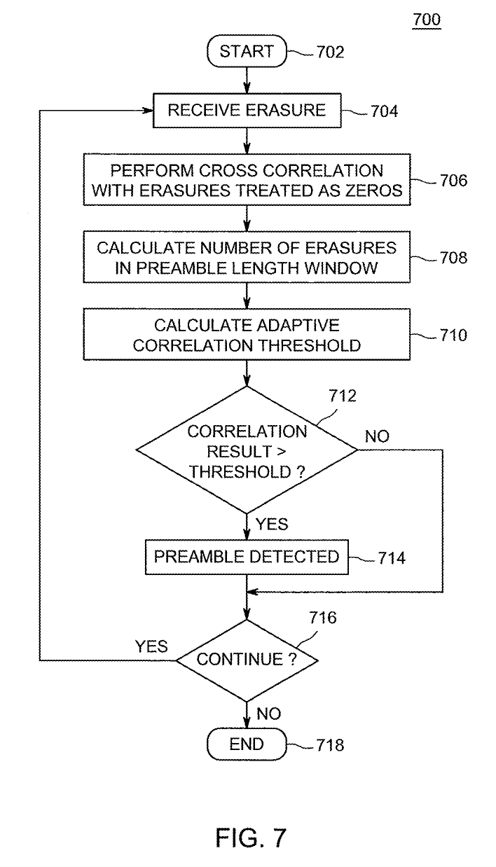

The memory 344 may store various forms of application software, such as an impulse noise ED module 304 and a modified PD module 306 for performing the impulse noise mitigation techniques described herein. The functionality of the impulse noise ED module 318 is described in detail below with respect to FIG. 6, and the functionality of the modified PD module 320 is described in detail below with respect to FIG. 7. The memory 314 may further store modules for performing the functions of the additional receiver components, such as an ADC module 320, a downconverter/filtering module 322, a delay module 326, an erasure detector module 310, a RS decoder module 308, a de-scrambler module 332, an AGC module 324, a delay module 302, a polar discriminator module 328, and a synchronization/equalization and symbol decision module 330. The delay module 302, the impulse noise erasure detector module 304, the polar discriminator 328, and the modified packet detector module 306. The memory 314 may further store a database 360 for storing data, such as data related to the present invention (e.g., one or more thresholds as well as other types of data).

FIG. 4 is a block diagram of a system 400 for power conversion using one or more embodiments of the present invention. This diagram only portrays one variation of the myriad of possible system configurations and devices that may utilize the present invention. The present invention can be utilized by any packet communication device that may experience impulse noise, and can function in a variety of distributed environments and systems requiring communications that may experience impulse noise.

The system 400 comprises a plurality of DC-AC inverters 402₁, 402₂ . . . 402ₙ, collectively referred to as inverters 402, a plurality of DC power sources 404-1, 404-2, 404-3 . . . 404-N, collectively referred to as DC power sources 404, a plurality of power line communications transceiver (PLCTs) 104₁, 104₂ . . . 104ₙ, 104ₙ₊₁, collectively referred to as PLCTs 104, AC power line 406, an inverter controller 410, and a load center 408. The DC power sources 404 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. Although DC-AC inverters are shown in FIG. 4, in other embodiments other types of power conversion devices may be employed (e.g., DC-DC converters).

Each inverter 402₁, 402₂ . . . 402ₙ is coupled to a PLCT 104₁, 104₂ . . . 104ₙ, respectively; in some alternative embodiments, each of the PLCTs 104₁, 104₂ . . . 104ₙ may be contained within the corresponding inverter 402₁, 402₂ . . . 402ₙ. Each inverter 402₁, 402₂ . . . 402ₙ is additionally coupled to a DC power source 404₁, 404₂ . . . 404ₙ, respectively. The inverter controller 410 is coupled to the PLCT 104ₙ₊₁ and is capable of communicating with the inverters 402 via the PLCTs 104 and/or via wireless communication for receiving data from the inverters 402 and providing operative control of the inverters 402.

The AC power line 406 is further coupled to the load center 408 which houses connections between incoming commercial AC power lines from a commercial AC power grid distribution system and the AC power line 406. The inverters 402 convert DC power generated by the DC power sources 404 into AC power, and couple the generated AC power to the commercial AC power grid via the load center 408; additionally or alternatively, the generated power may be distributed for use, for example to one or more appliances, and/or the generated energy may be stored for later use, for example using batteries, heated water, hydro pumping, H₂O-to-hydrogen conversion, or the like.

The inverters 402 communicate with other devices (such as among one another, with the inverter controller 410, and/or other devices not shown) using power line communications over the AC power lines 406 via the PLCTs 104. In accordance with one or more embodiments of the present invention, receivers of the PLCTs 104 each comprise the impulse noise mitigation module 122 described herein to perform the impulse noise mitigation techniques described herein.

FIG. 5 is a functional block diagram of another embodiment of a receiver 108 in accordance with one or more embodiments of the present invention. In the receiver 108 depicted in FIG. 5, modulation techniques other than FSK are used, such as minimum-shift keying (MSK), binary phase-shift keying (BPSK), quadrature phase-shift keying (QPSK), quadrature amplitude modulation (QAM), or the like.

The receiver 108 of FIG. 5 comprises the ADC 220 that receives an analog input from the coupler 110 and converts the received analog input to a digital output that is coupled to the down-conversion module 222. The down-conversion module 222 converts the received signal to a baseband signal and performs low-pass filtering to remove high-frequency content.

The output from the down-conversion module 222 is coupled to the AGC module 224, and an output from the AGC module 224 is coupled to the delay module 226 and an impulse noise erasure detector (ED) module 504 (an implementation of the impulse noise ED module 318) which operates analogous to the ED module 204 described above. An output from the AGC module 224 is coupled to a delay module 502 (analogous to the delay module 202 described above), and the outputs from the delay module 502 and the impulse noise ED module 504 are coupled to a modified PD module 506 (an implementation of the modified PD module 320) which operates analogous to the modified PD module 206 described above. The delay module 502, the impulse noise ED module 504, and the PD module 506 form the EDPD module 122 for impulse noise mitigation. As in the receiver 108 depicted in FIG. 2, the output from the PD 506 (i.e., the output from the EDPD module 122) is coupled to the synchronization/equalization and symbol decision module 230.

In addition to coupling an output to the delay module 502, the AGC module 224 couples an output to the delay module 226, and the output from the delay module 226 is coupled to the ED module 210. The outputs from the ED module 210 and the synchronization/equalization and symbol decision module 230 are each coupled to a de-interleaver/RS decoder 508. The RS-corrected symbols output from the de-interleaver/RS decoder 508 are coupled to the de-scrambler module 232 for de-scrambling; and the output from the de-scrambler 232 is coupled to the device 102. In some embodiments, the ED module 210 may couple an output to the synchronization/equalization and symbol decision module 230.

Analogous to the receiver 108 depicted in FIG. 2, the ED module 210 feeds erasures to the de-interleaver/RS decoder 508 which performs both de-interleaving and RS decoder functions for correcting symbols in the payload that have been corrupted by impulse noise as known in the art. Additionally, the EDPD module 122 employs impulse noise mitigation for packet preamble detection as described above.

FIG. 6 (comprised of FIGS. 6a and 6b) is a flow diagram of a method 600 for generating erasures for impulse noise mitigation during power line communication packet preamble detection in accordance with one or more embodiments of the present invention. In one or more embodiments, the method 600 is an implementation of the impulse noise ED module 318. In some embodiments, a computer readable medium comprises a program that, when executed by a processor, performs the method 600 that is described below.

The method 600 starts at step 602 and proceeds to step 604. At step 604, a moving average, referred to as “moving average 2”, is reset. At step 606, another moving average, referred to as “moving average 1” is reset; additionally, and end of gap (EOG) count is reset. The method 600 proceeds to step 608.

At step 608, a smoothed AGC gain sample is received. In some embodiments, the AGC gain is smoothed using a 1 pole Infinite Impulse Response (IIR) filter with one programmable coefficient having values such as 0.5, 0.75, 0.875, 0.9375, 0.96875, 0.984375, and the like. The method 600 proceeds to step 610, where a determination is made whether the received sample is less than an AGC gain sample threshold. The AGC gain sample threshold is employed to detect when an (inter-frame) gap stops and the signal starts. In some embodiments, the AGC gain sample threshold is set based on a measured signal-to-noise ratio.

If, at step 610, the result of the determination is no (i.e., the sample is equal to or greater than the threshold), the sample represents a gap sample. The method 600 proceeds to step 611 where a determination is made whether an EOG has been detected. If the result of the determination is yes, than an EOG has been detected, the method 600 proceeds to step 616. If the result of the determination at step 611 is no, that an EOG has not been determined, the method 600 returns to step 606.

If, at step 610, the result of the determination is yes (i.e., the sample is less than the threshold), the sample represents a packet sample and the method 600 proceeds to step 612. At step 612, a determination is made whether an EOG has been detected based on the EOG count. If the result of the determination at step 612 is no, that an EOG has not been detected based on the EOG count, the method 600 proceeds to step 614 where the EOG count is incremented and the method 600 then proceeds to step 616.

If, at step 612, the result of the determination is yes, that the EOG has been detected based on the EOG count, the method 600 proceeds to step 616. At step 616, the moving average 1 and the moving average 2 are each computed using the received sample. The ramp-up length of moving average 1 is configurable; for example, the ramp-up length may be set to 32, 64, 128, or the like. The method 600 then proceeds to step 617 where a determination is made if ramp up is done. If at step 617 it is determined that the ramp up is not done, the method 600 proceeds to step 618 where a determination is made whether the moving average 1 is equal to a particular moving average length (e.g., 2, 4, 8, 16, 32, 64 or 128). If the result of the determination is no, that the moving average 1 is not equal to the moving average length, the method 600 proceeds to step 642 where the moving average 2 is stored in a buffer. The method 600 then returns to step 608. If, at step 618, the result of the determination is yes, that the moving average 1 is equal to the moving average length, the method 600 proceeds to step 619 where the ramp up is done and the address of the moving average 2 buffer is set to zero. The method 600 then proceeds step 620 where the final ramp-up moving average 1 value is registered and the final moving average 1 value will be used for the previous samples that were in the ramp-up window. The method 600 then proceeds to step 630.

At step 630, the registered moving average 1 is used for ramp up samples. At step 632, the moving average 2 is read from the buffer. At step 634, a determination is made whether the moving average 1 is greater than the moving average 2 plus an erasure margin. In some embodiments, the erasure margin may be set based on a measured signal-to-background noise ratio. If the result of the determination at step 634 is no, i.e., that the moving average 1 is less than or equal to the moving average 2 plus the erasure margin, no erasure has been detected and the method 600 returns to step 608. If the result of the determination at step 634 is yes, an erasure has been detected and the method 600 proceeds to step 636 where the sample is marked as an erasure.

The method 600 proceeds to step 638, where a determination is made whether reading of the moving average 2 buffer is done. If the result of the determination at step 638 is yes, the method 600 returns to step 608; if the result of the determination at step 638 is no, the method 600 proceeds to step 640. At step 640, the address of the moving average 2 buffer is incremented and the method 600 returns to step 630.

If, at step 617, it is determined that the ramp up is done, the method 600 proceeds to step 622. At step 622, a determination is made whether the moving average 1 is greater than the moving average 2 plus an erasure margin. In some embodiments, the erasure margin may be set based on a measured signal-to-background noise ratio. If the result of the determination at step 622 is no, i.e., that the moving average 1 is less than or equal to the moving average 2 plus the erasure margin, no erasure has been detected and the method 600 returns to step 608.

If the result of the determination at step 622 is yes, i.e., that the moving average 1 is greater than the moving average 2 plus the erasure margin, an erasure has been detected and the method 600 proceeds to step 624. At step 624, the sample is marked as an erasure. The identified erasure may then be used in packet preamble detection, for example as described below with respect to FIG. 7.

The method 600 proceeds to step 626 where a determination is made whether to continue. If the result of the determination at step 626 is yes, the method 600 returns to step 608. If the result of the determination at step 626 is no, the method 600 proceeds to step 628 where it ends.

FIG. 7 is a flow diagram of a method 700 for using erasures for power line communication impulse noise mitigation during packet preamble detection in accordance with one or more embodiments of the present invention. In one or more embodiments, the method 700 is an implementation of the modified PD module 320. In some embodiments, a computer readable medium comprises a program that, when executed by a processor, performs the method 700 that is described below.

The method 700 begins at step 702 and proceeds to step 704. At step 704, an erasure is received, such as an erasure generated by the method 600 described above. At step 706, a cross correlation is performed between a known sequence and received samples, where the erasures are treated as zeroes during the correlation. In some embodiments, a hard decision cross correlation (HDCC) for packet detection and a soft decision cross correlation (SDCC) for header start and symbol boundary are performed using the erasures.

At step 708, the number of erasures in a preamble-length window is computed and scaled. The method 700 proceeds to step 710, where the information generated at step 708 is used to adaptively scale a correlation threshold for packet preamble detection. Because the erased preamble samples produce a correlation intermediate result of zero, the correlation threshold must be reduced accordingly as the number of erasures increases. For example, in one or more embodiments where a 64-symbol correlation is used, the correlation threshold for preamble detection would be adjusted by (number of erasures)/64. By using this adaptive scaling, a preamble where 48 out of 64 symbols have been erased and only 16 symbols are valid can still be detected. In some embodiments, these techniques can be utilized with a longer preamble to realize 4 msec impulse noise mitigation.

In some embodiments, correlation thresholds for each of the HDCC and the SDCC are adaptively set.

At step 712, a determination is made whether the correlation result is greater than the correlation threshold. If the result of the determination at step 712 is yes, that the correlation result is greater than the threshold, the method 700 proceeds to step 714 where a preamble is detected; the method 700 then proceeds to step 716. If the result of the determination at step 712 is no, that the correlation result is not greater than the threshold, the method 700 proceeds to step 716.

At step 716 a determination is made whether to continue. If the result of the determination is yes, the method 700 returns to step 704; if the result of the determination is no, the method 700 proceeds to step 718 where it ends.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A method for impulse noise mitigation, comprising:
identifying one or more impulse noise affected samples of a communication signal transmitted via power line communications;
creating, based on the identified one or more impulse-noise affected samples, one or more erasures; and
adaptively controlling a correlation threshold for packet preamble detection, wherein the correlation threshold is adaptively controlled based on the one or more erasures.

2. The method of claim 1, wherein creating the one or more erasures comprises marking each impulse noise affected sampled of the one or more impulse noise affected samples.

3. The method of claim 2, wherein identifying the one or more impulse-noise affected samples comprises:
receiving a plurality of samples of the communication signal;
determining when a number of consecutive samples of the plurality of samples are each less than a gain sample threshold;
computing a first moving average based on the consecutive samples;
computing a second moving average based on samples of the plurality of samples that are less than the gain sample threshold;
comparing the first moving average to an erasure threshold that is based on the second moving average; and
identifying, when the first moving average is greater than the erasure threshold, the one or more impulse noise affected samples.

4. The method of claim 3, wherein adaptively controlling the correlation threshold comprises computing the correlation threshold based on a number of erasures in a preamble-length window.

5. The method of claim 4, further comprising performing a cross-correlation between the plurality of samples and a known sequence, wherein each erasure of the one or more erasures is treated as a zero during the cross-correlation.

6. The method of claim 5, further comprising:
comparing a result of the cross-correlation to the correlation threshold; and
identifying a packet preamble when the result of the cross-correlation is greater than the correlation threshold.

7. The method of claim 6, wherein performing the cross-correlation comprises performing a hard decision cross-correlation.

8. The method of claim 3, further comprising:
comparing the first moving average to a length threshold; and
when the first moving average is equal to the length threshold, replacing previous samples in a first moving average ramp-up window by the first moving average.

9. The method of claim 3, wherein the erasure threshold is equal to the second moving average plus a margin value.

10. An apparatus for impulse noise mitigation, comprising:
an erasure detection for packet detector (EDPD) module for (i) identifying one or more impulse noise affected samples of a communication signal transmitted via power line communications; (ii) creating, based on the identified one or more impulse-noise affected samples, one or more erasures; and (iii) adaptively controlling a correlation threshold for packet preamble detection, wherein the correlation threshold is adaptively controlled based on the one or more erasures.

11. The apparatus of claim 10, wherein the EDPD module comprises an impulse noise erasure detector module for marking each impulse noise affected sampled of the one or more impulse noise affected samples to create the one or more erasures.

12. The apparatus of claim 11, wherein the EDPD module receives a plurality of samples of the communication signal and the impulse noise erasure detector module identifies the one or more impulse-noise affected samples by:
determining when a number of consecutive samples of the plurality of samples are each less than a gain sample threshold;
computing a first moving average based on the consecutive samples;
computing a second moving average based on samples of the plurality of samples that are less than the gain sample threshold;
comparing the first moving average to an erasure threshold that is based on the second moving average; and
identifying, when the first moving average is greater than the erasure threshold, the one or more impulse noise affected samples.

13. The apparatus of claim 12, wherein the EDPD module comprises a packet detector module that adaptively controls the correlation threshold by computing the correlation threshold based on a number of erasures in a preamble-length window.

14. The apparatus of claim 13, wherein the packet detector module further performs a cross-correlation between the plurality of samples and a known sequence, wherein each erasure of the one or more erasures is treated as a zero during the cross-correlation.

15. The apparatus of claim 14, wherein the packet detector module further compares a result of the cross-correlation to the correlation threshold; and identifies a packet preamble when the result of the cross-correlation is greater than the correlation threshold.

16. The apparatus of claim 15, wherein performing the cross-correlation comprises performing a hard decision cross-correlation.

17. The apparatus of claim 12, wherein the impulse noise erasure detector module further compares the first moving average to a length threshold and, when the first moving average is equal to the length threshold, replaces previous samples in a first moving average ramp-up window by the first moving average.

18. The apparatus of claim 12, wherein the erasure threshold is equal to the second moving average plus a margin value.

19. A system for mitigating power line communication impulse noise, comprising:
a plurality of renewable energy sources;
a plurality of inverters coupled to the plurality of renewable energy sources in a one-to-one correspondence, wherein the plurality of inverters is coupled to a power line; and
a plurality of power line communication transceivers (PLCT) coupled to the plurality of inverters in a one-to-one correspondence, wherein the plurality of PLCTs is coupled to the power line and wherein each PLCT of the plurality of PLCTs comprises an erasure detection for packet detector (EDPD) module for (i) identifying one or more impulse noise affected samples of a communication signal transmitted via power line communications; (ii) creating, based on the identified one or more impulse-noise affected samples, one or more erasures; and (iii) adaptively controlling a correlation threshold for packet preamble detection, wherein the correlation threshold is adaptively controlled based on the one or more erasures.

20. The system of claim 19, wherein the plurality of renewable energy sources is a plurality of photovoltaic (PV) modules.
